(19) United States
(12) Patent Application Publication
(10) Pub. No.: US 2025/0011557 A1
(43) Pub. Date: Jan. 9, 2025

(54) POLYIMIDE FILM FOR GRAPHITE SHEET, AND GRAPHITE SHEET PREPARED THEREFROM

(71) Applicant: PI ADVANCED MATERIALS CO., LTD., Jincheon-gun (KR)

(72) Inventors: Hyeong-Seop JUNG, Cheonan-si (KR); Dong-Young WON, Jincheon-gun (KR)

(21) Appl. No.: 18/710,090

(22) PCT Filed: Nov. 16, 2022
(86) PCT No.: PCT/KR2022/018054

§ 371 Date: May 14, 2024

(30) Foreign Application Priority Data
Nov. 16, 2021 (KR) 10-2021-0157397

(51) Int. Cl. C08J 5/18; C01B 32/205; C08G 73/10

(52) U.S. Cl. CPC C08J 5/18; C01B 32/205; C08G 73/1021; C01P 2004/20; C08J 2379/08

(57) ABSTRACT

The present invention provides a polyimide film and a graphite sheet prepared therefrom, wherein the polyimide film is obtained by an imidication reaction of a polyamic acid comprising: quinoline and β-picoline as imidication catalysts; and acetic anhydride as a dehydrating agent.

### TECHNICAL FIELD

The present disclosure relates to polyimide films for graphite sheets and graphite sheets prepared therewith.

### BACKGROUND ART

Recently, electronic devices have become lighter, smaller, thinner, and more highly integrated. As a result, significant heat is generated in electronic devices. This heat can shorten the lifespan of the product or cause breakdown or malfunction thereof. Therefore, thermal management of electronic devices has emerged as an important issue.

Graphite sheets have higher thermal conductivity than metal sheets of copper or aluminum and are attracting attention as heat dissipation members for electronic devices. In particular, research is being actively conducted on high-thickness graphite sheets (for example, graphite sheets with a thickness of about 50 μm or more), which are advantageous in terms of heat capacity compared to thin graphite sheets (for example, graphite sheets with a thickness of about 40 μm or less).

Graphite sheets can be prepared in a variety of ways, for example, by carbonizing polymer films and graphitizing polymer films. In particular, polyimide films are attracting attention as polymer films used for preparing graphite sheets due to the excellent mechanical, thermal, dimensional, and chemical stabilities thereof.

To prepare high thickness graphite sheets, the preparation of high thickness polyimide films is required. The conventional method of preparing polyimide films is by casting and heat-treating a polyamic acid solution. The conventional method makes it difficult to evenly cure the inside and outside of the films, resulting in split layers and bubbles. Thus, there is a problem in preparing high thickness polyimide films.

In other words, due to the thickness of the high thickness polyimide films, the drying speed of the surface and interior of the polyimide films varies, making it difficult to discharge internally generated gas. Besides the thickness-related issue, the degree of orientation between the surface and interior of the films could vary, making it unable to withstand the volume change that occurs during the graphite preparation process. Thus, the shape of the films is not maintained.

In particular, the tensile strain of polyimide films of the same composition decreases as the thickness thereof increases.

Meanwhile, to make high thickness polyimide films that can be graphitized, the tensile strain of the films is required to be maintained above a certain level. However, when the overall tensile strain is lowered, multiple fractures occur during the film-forming process, greatly reducing process efficiency.

Plasticizers are used to prevent such fractures, but when plasticizers are used, it is difficult to control the foamed thickness of graphite sheets, and the graphite sheets have a characteristic of reduced heat diffusion.

### RELATED ART DOCUMENT

### Patent Document

(Patent Document 1) Korean Patent Application Publication No. 10-2017-0049912

### DISCLOSURE

### Technical Problem

The present disclosure is to provide high thickness polyimide films for graphite sheets, the high thickness polyimide films securing the uniform properties of the surface and interior thereof by using two types of imidization catalysts together and having excellent tensile strain properties that do not cause fractures during film preparation.

The present disclosure is also to provide a method of preparing graphite sheets with the polyimide films and to provide graphite sheets of excellent quality prepared therewith.

### Technical Solution

In one embodiment of the present disclosure for achieving the objectives, polyimide films are provided.

The films are obtained by imidizing polyamic acid containing acetic anhydride as a dehydrating agent and having quinoline and β-picoline as imidization catalysts and

having quinoline and β-picoline as imidization catalysts.

In another embodiment of the present disclosure, a method of preparing graphite sheets is provided,

the method including carbonizing the polyimide films, graphitizing the polyimide films, or carbonizing and graphitizing the polyimide films.

In yet another embodiment of the present disclosure, graphite sheets prepared by the graphite sheet preparation method are provided.

### Advantageous Effects

The present disclosure has the effect of providing high thickness polyimide films securing the uniform properties of the surface and interior by using two types of imidization catalysts together and having excellent tensile strain properties that do not cause fractures during film preparation, providing a method of preparing graphite sheets with the polyimide films, and providing the graphite sheets with excellent properties prepared therewith.

### BEST MODE

Hereinafter, the embodiments and examples of the present disclosure will be described in detail so that those skilled in the art can easily practice the disclosure. However, the present disclosure may be implemented in various different forms and is not limited to the implementation embodiments and examples described herein. Throughout this specification, when a part ‘includes’ a certain component, this means that the part may further include other components rather than excluding other components unless specifically stated to the contrary.

In this specification, singular expressions include plural expressions, unless the context clearly dictates otherwise.

When interpreting a component, the component is interpreted to include the margin of error even if there is no separate explicit description.

In the specification, in ‘a to b’ indicating a numerical range, ‘to’ is defined as ≥a and ≤b.

According to one embodiment of the present disclosure, polyimide films may be obtained by imidizing polyamic acid containing acetic anhydride as a dehydrating agent and

having quinoline and β-picoline as imidization catalysts.

When only one type of imidization catalyst is used, the curing temperature at the beginning of the imidization reaction is low. In an imidization reaction with a fast speed of curing, the catalyst may have difficulty in lowering the curing degree of the polyimide films. Additionally, when the speed of curing is too fast, process problems, such as shrinkage during the drying process, may occur, making it difficult to carry on to subsequent processes.

On the other hand, when the initial reaction rate of the imidization reaction is slow, the imidization catalyst may remain for a long time, or the initial reaction rate of the imidization reaction is fast. However, the imidization catalyst may evaporate quickly, resulting in insufficient polyimide after the initial imidization reaction.

Therefore, imidization for polyimide films can be controlled by mixing two types of catalysts that have different reaction rates and can affect the initial and late imidization reactions, respectively.

That is, a basic reaction occurs at the beginning of the imidization reaction using an imidization catalyst that induces a fast initial imidization reaction rate, thereby the uniform surface and interior can be ensured while the degree of rigidity can be appropriately achieved in subsequent processes.

At the same time, an imidization catalyst that operates at a high reaction temperature while inducing a slow imidization reaction rate is used. The catalyst remains until the latter half of the film-forming process of the polyimide films, thereby improving the mechanical properties of the polyimide films and improving processability.

In particular, when preparing the polyimide films, quinoline can contribute to securing sufficient imidization time by helping imidization proceed even in high-temperature sections during the preparation process. However, when quinoline is not used together with β-picoline, gel films will not be formed and polyimide films cannot be obtained.

In addition, when only β-picoline was used without quinoline, the tensile strain properties were greatly reduced.

That is, when quinoline and β-picoline are used individually instead of together, polyimide films may not be obtained, or the physical properties (tensile deformation characteristics) of the polyimide films may deteriorate.

In one embodiment, the quinoline may be contained in an amount in a range of 0.1 mol % or more and 1.5 mol % or less, based on 1 mol of amic acid groups in the polyamic acid. The β-picoline may be contained in an amount in a range of 0.1 mols or more and 1 mol % or less based on 1 mol of amic acid groups in the polyamic acid.

In another embodiment, the ratio of the mold of the quinoline and the mol % of the β-picoline (mol % of quinoline/mol % of β-picoline) may be in a range of 1 or more and 3 or less.

When the content of the quinoline and β-picoline is outside the range, respectively, the physical properties (tensile deformation characteristics) of the polyimide films may decrease, or excessive shrinkage may occur, thereby the polyimide films may not be formed.

In yet another embodiment, the acetic anhydride may be contained in an amount in a range of 1 mol& or more and 4 mol % or less based on 1 mol of amic acid groups in the polyamic acid.

When the acetic anhydride is above or below the range, shrinkage may occur in the polyimide films, or a curing reaction may not occur, thereby the polyimide films may not be formed.

In yet another embodiment, the ratio of the mol % of the β-picoline and the mol % of the acetic anhydride (mol % of β-picoline/mol % of acetic anhydride) may be in a range of 0.11 or more and 0.50 or less.

In yet another embodiment, the polyamic acid may contain dimethylformamide (DMF) in an amount in a range of 1 mol % or more and 3 mol % or less, based on 1 mol of amic acid groups in the polyamic acid.

Meanwhile, the polyimide films may be prepared by imidizing polyamic acid which is formed through the reaction of dianhydride monomer and diamine monomer. The polyamic acid may have a weight average molecular weight in a range of 100,000 to 500,000. Within the range, graphitization may be easy when preparing graphite sheets. Here, ‘weight average molecular weight’ may be measured using gel chromatography (GPC) and polystyrene as a standard sample. The weight average molecular weight of the polyamic acid may be, for example, 150,000 to 500,000, for example, 100,000 to 400,000, or for another example, 250,000 to 400,000, but is not limited thereto.

As the dianhydride monomer and diamine monomer, various monomers commonly used in the field of polyimide film preparation can be used. For example, the dianhydride monomer may be an aromatic dianhydride monomer, and the diamine monomer may be an aromatic diamine monomer. The dianhydride monomer may include dyromelliticacid dianhydride, 3,3′,4,4′-biphenyltetracarboxylicacid dianhydride, 2,3,3′,4′-biphenyltetracarboxylicacid dianhydride, oxydiphthalic dianhydride, diphenylsulfone-3,4,3′,4′-tetracarboxylic dianhydride, bis(3,4-dicarboxyphenyl) sulfide dianhydride, 2,2-bis(3,4-dicarboxyphenyl)-1,1,1,3,3,3-hexafluoropropane dianhydride, 2,3,3′,4′-benzophenonetetracarboxylicacid dianhydride, 3,3′,4,4′-benzophenonetetracarboxylicacid dianhydride, bis(3,4-dicarboxyphenyl) methane dianhydride, 2,2-bis(3,4-dicarboxyphenyl)propane dianhydride, p-phenylenebis(trimelliticacid monoester anhydride), p-biphenylenebis(trimelliticacid monoester anhydride), In-terphenyl-3,4,3′,4′-tetracarboxylic dianhydride, p-terphenyl-3,4,3′,4′-tetracarboxylicacid dianhydride, 1,3-bis(3,4-dicarboxyphenoxy)benzene dianhydride, 1,3-bis(3,4-dicarboxyphenoxy)benzene dianhydride, 1,4-bis(3,4-dicarboxyphenoxy)biphenyl dianhydride, 1,4-bis(3,4-dianhydride, 2,2-bis[(3,4-dicarboxy phenoxy)phenyl]propane dianhydride, 2,3,6,7-naphthalenetetracarboxylicacid dianhydride, 1,4,5,8-naphthalenetetracarboxylicacid dianhydride, and 4,4′-(2,2-hexafluoroisopropylidene)diphthalic dianhydride, or combinations thereof, but is not limited thereto. The diamine monomer may include a diamine monomer containing one benzene ring (for example, 1,4-diaminobenzene, 1,3-diaminobenzene, 2,4-diaminotoluene, 2,6-diaminotoluene, and 3,5-diaminobenzene, minobenzoic acid), a diamine monomer containing two benzene rings (for example, diaminodiphenylether, such as 4,4′-diaminodiphenylether and 3,4′-diaminodiphenylether, 4,4′-diaminodiphenylmethane, 3,3′-dimethyl-4,4′-diaminobiphenyl, 2,2′-dimethyl-4,4′-diaminobiphenyl, 2,2′-bis(trifluoromethyl)-4,4′-diaminobiphenyl, 3,3′-dimethyl-4,4′-diaminodiphenylmethane, 3,3′-dicarboxy-4,4′-diaminodiphenylmethane, 3,3′,5,5′-tetramethyl-4,4′-diaminodiphenylmethane, bis(4-aminophenyl)sulfide, 4,4′-diaminobenzanilide, 3,3′-dimethylbenzidine, 2,2′-dimethylbenzidine, 3,3′-dimethoxybenzidine, 2,2′-dimethoxybenzidine, 3,3′-diaminodiphenylether, 3,4′-diaminodiphenylether, 4,4′-diaminodiphenylether, 3,3′-diaminodiphenylsulfide, 3,4′-diaminodiphenylsulfide, 4,4′-diaminodiphenylsulfide, 3,3′-diaminodiphenylsulfone, 3,4′-diaminodiphenylsulfone, 4,4′-diaminodiphenylsulfone, 3,3′-diaminobenzophenone, 4,4′-diaminobenzophenone, 3,3′-diamino-4,4′-dichlorobenzophenone, 3,3′-diamino-4,4′-dimethoxybenzophenone, 3,3′-diaminodiphenylmethane, 3,4′-diaminodiphenylmethane, 4,4′-diaminodiphenylmethane, 2,2-bis(3-aminophenyl)propane, 2,2-bis(4-aminophenyl)propane, 2,2-bis(3-aminophenyl)-1,1,1,3,3,3-hexafluoropropane, 2,2-bis(4-aminophenyl)-1, 1,1,3,3,3-hexafluoropropane, 3,3′-diaminodiphenylsulfoxide, 3,4′-diaminodiphenylsulfoxide, and 4,4′-diaminodiphenyl sulfoxide), a diamine monomer containing 3 benzene rings (for example, 1,3-bis(3-aminophenyl)benzene, 1,3-bis(4-aminophenyl)benzene, 1,4-bis(3-aminophenyl)benzene, 1,4-bis(4-aminophenyl)benzene, 1,3-bis(4-aminophenoxy)benzene, 1,4-bis(3-aminophenoxy)benzene, 1,3-bis(3-aminophenoxy)-4-trifluoromethylbenzene, 3,3′-diamino-4-(4-phenyl)phenoxybenzophenone, 3,3′-diamino-4,4′-di(4-phenylphenoxy)benzophenone, 1,3-bis(3-aminophenylsulfide)benzene, 1,3-bis(4-aminophenylsulfide)benzene, 1,4-bis(4-aminophenylsulfide)benzene, 1,3-bis(3-aminophenylsulfone)benzene, 1,3-bis(4-aminophenylsulfone)benzene, 1,4-bis(4-aminophenylsulfone)benzene, 1,3-bis[2-(4-aminophenyl)isopropyl]benzene, 1,4-bis[2-(3-aminophenyl)isopropyl]benzene, and 1,4-bis[2-(4-amino)phenyl)isopropyl]benzene), and a diamine monomer containing 4 benzene rings (for example, 3,3′-bis(3-aminophenoxy)biphenyl, 3,3′-bis(4-aminophenoxy)biphenyl, 4,4′-bis(3-aminophenoxy)biphenyl, 4,4′-bis(4-aminophenoxy)biphenyl, bis[3-(3-aminophenoxy)phenyl]ether, bis[3-(4-aminophenoxy)phenyl]ether, bis[4-(3-aminophenoxy)phenyl]ether, bis[4-(4-aminophenoxy)phenyl]ether, bis[3-(3-aminophenoxy)phenyl]ketone, bis[3-(4-aminophenoxy)phenyl]ketone, bis[4-(3-aminophenoxy)phenyl]ketone, bis[4-(4-aminophenoxy)phenyl]ketone, bis[3-(3-aminophenoxy)phenyl]sulfide, bis[3-(4-aminophenoxy)phenyl]sulfide, bis[4-(3-aminophenoxy)phenyl]sulfide, bis[4-(4-aminophenoxy)phenyl]sulfide, bis[3-(3-aminophenoxy)phenyl]sulfone, bis[3-(4-aminophenoxy)phenyl]sulfone, bis[4-(3-aminophenoxy)phenyl]sulfone, bis[4-(4-aminophenoxy)phenyl]sulfone, bis[3-(3-aminophenoxy)phenyl]methane, bis[3-(4-aminophenoxy)phenyl]methane, bis[4-(3-aminophenoxy)phenyl]methane, bis[4-(4-aminophenoxy)phenyl]methane, 2,2-bis[3-(3-aminophenoxy)phenyl]propane, 2,2-bis[3-(4-aminophenoxy)phenyl]propane, 2,2-bis[4-(3-amino) phenoxy)phenyl]propane, 2,2-bis[4-(4-aminophenoxy)phenyl]propane, 2,2-bis[3-(3-aminophenoxy)phenyl]-1,1,1,3,3,3-hexafluoropropane, 2,2-bis[3-(4-aminophenoxy)phenyl]-1,1,1,3,3,3-hexafluoropropane, 2,2-bis[4-(3-aminophenoxy) Phenyl]-1,1,1,3,3,3-hexafluoropropane, and 2,2-bis[4-(4-aminophenoxy)phenyl]-1,1,1,3,3,3-hexafluoropropane), or combinations thereof, but is not limited thereto.

In particular, the dianhydride monomer may include pyromellitic dianhydride, 3,3′,4,4′-biphenyltetracarboxylicacid dianhydride, 2,3,3′,4-biphenyltetracarboxylicacid dianhydride, oxydiphthalic anhydride, bis(3,4-dicarboxyphenyl) sulfone dianhydride, and 3,3′,4,4′-benzophenonetetracarboxylicacid dianhydride, or combinations thereof. The diamine monomer may include 4,4′-oxydianiline, 3,4′-oxydianiline, p-phenylenediamine, m-phenylenediamine, 4,4′-methylenedianiline, and 3,3′-methylenedianiline, or combinations thereof.

In yet another embodiment, the polyimide films may have a thickness in a range of 50 μm or more. The thickness of the polyimide films may be in a range of, for example, 50 μm or more, 60 μm or more, 70 μm or more, 80 μm or more, 90 μm or more, 100 μm or more, 110 μm or more, 120 μm or more, 130 μm or more, 140 μm or more, 150 μm or more, 200 μm or more, 250 μm or more, 300 μm or more, 350 μm or more, 400 μm or more, 450 μm or more, or 500 μm or more, but is not limited thereto.

That is, the polyimide films may be highly thick polyimide films.

In yet another embodiment, the polyimide films may have a tensile strain in a range of 100% or more.

The polyimide films can be prepared by various methods commonly used in the polyimide film preparation field. For example, the polyimide films may be prepared as follows, but the film preparation is not limited to the following method. A polyamic acid solution is prepared by polymerizing one or more dianhydride monomers and one or more diamine monomers in a solvent. Later, imidization catalysts, a dehydrating agent, optionally sublimable inorganic fillers, and a solvent are added to the polyamic acid solution to form a composition for polyimide films, and the composition is formed into films.

The process of imidizing the polyamic acid solution may be performed through a known imidization method, such as a thermal imidization method, a chemical imidization method, or a composite imidization method, which is a combination of the thermal imidization method and the chemical imidization method.

All sublimable inorganic fillers contained in the polyimide films have an average particle diameter (D 50) in a range of 0.1 to 5.0 μm. The sublimable inorganic fillers may be contained in an amount of 0.07% to 0.4% by weight in total, based on the total weight of the polyimide films.

The sublimable inorganic fillers may induce a predetermined foaming phenomenon by sublimating when carbonizing the polyimide films, graphitizing the polyimide films, or carbonizing and graphitizing the polyimide films. This foaming phenomenon can facilitate the exhaustion of sublimation gas generated during carbonization, graphitization, or both, making it possible to obtain high-quality graphite sheets. The pores formed during foaming can also improve the bending resistance (‘flexibility’) of the graphite sheets.

However, excessive foaming and the resulting numerous pores can significantly deteriorate the thermal conductivity and mechanical properties of the graphite sheets. The type, content, and particle size of the sublimable inorganic fillers are required to be carefully selected, as the sublimable inorganic fillers may cause defects in the surface of the graphite sheets.

‘Average particle size (D 50)’ may be measured using a laser diffraction particle size analyzer (SALD-2201, Shimadzu) after ultrasonically dispersing the sublimable inorganic fillers in dimethylformamide solvent at a temperature of 25° C. for 5 minutes.

The average particle diameter (D 50) of the entire sublimable inorganic fillers in the polyimide films may be in a range of, for example, 0.5 to 4.0 μm, for another example, 0.1 to 2.5 μm, for yet another example, 1.5 to 5.0 μm, for yet another example, less than 1.5 to 2.5 μm, but is not limited thereto. The sublimable inorganic fillers in the polyimide films may be contained in total in an amount of, for example, 0.07% to 0.35% by weight, for another example, 0.1% to 0.3% by weight, for yet another example, 0.15% to 0.3% by weight, based on the total weight of the polyimide films, but the content is not limited to the mentioned above.

The sublimable inorganic filler may include a first sublimable inorganic filler having an average particle diameter (D 50) in a range of 0.1 to 2.0 μm and a second sublimable inorganic filler having an average particle diameter (D 50) in a range of more than 2.0 to 5.0 μm.

Among the sublimable inorganic fillers, the content of the first sublimable inorganic filler and the second sublimable inorganic filler is not particularly limited, but, for example, based on the total weight of the sublimable inorganic fillers, the first sublimable inorganic filler may be contained in an amount of 90% to 10% by weight, and the second sublimable inorganic filler may be contained in an amount of 10% to 90% by weight. For example, as based on the total weight of the sublimable inorganic fillers, the content of the first sublimable inorganic filler may be contained in an amount of, for example, 15% to 85% by weight, for another example, 20% to 80% by weight, for yet another example, 30% to 80% by weight, for yet another example, 50% to 80% by weight and the second sublimable inorganic filler may be contained in an amount of, for example, 85% to 15% by weight, for another example, 80% to 20% by weight, for yet another example, 70% to 20% by weight, and for yet another example, 50% to 20% by weight. However, the content of the two fillers is not limited thereto.

The sublimable inorganic fillers may include calcium carbonate, dicalcium phosphate, and barium sulfate, but are not limited thereto.

The solvent is not particularly limited as long as the solvent can dissolve the polyamic acid. For example, the solvent may include an aprotic polar solvent.

In particular, the solvent may be used alone or in combination of two or more of sulfoxide-based solvents such as dimethyl sulfoxide and diethyl sulfoxide; formamide-based solvents such as N, N-dimethylformamide and N, N-diethylformamide; acetamide-based solvents such as N, N-dimethylacetamide and N, N-diethylacetamide; pyrrolidone-based solvents such as N-methyl-2-pyrrolidone and N-vinyl-2-pyrrolidone; Phenol-based solvents such as phenol, o-, m-, or p-cresol, xylenol, halogenated phenol, and catechol; and aprotic polar solvents such as hexamethylphosphoramide and γ-butylolactone, but is not limited thereto.

The dehydrating agent may be used alone or in combination of two or more of acetic anhydride, propionic anhydride, butyric anhydride, and benzoic anhydride, but is not limited thereto.

For the film forming, the polyamic acid solution is applied in the form of a film onto a substrate, heated and dried at a temperature in a range of 30° C. to 200° C. for 15 seconds to 30 minutes to prepare a gel film, and then the gel film with the substrate removed was heat-treated at a temperature in a range of 250° C. to 600° C. for 15 seconds to 30 minutes, but the film forming is not limited to thereto.

In yet another embodiment, the polyimide films may be ones used for preparing graphite sheets.

When preparing the graphite sheets using the polyimide films, it is possible to prepare the graphite sheets with excellent properties.

In yet another embodiment, a method of preparing the graphite sheets includes carbonizing polyimide films, graphitizing polyimide films, or carbonizing and graphitizing polyimide films.

Carbonization is a process of thermally decomposing the polymer chain of polyimide films to form preliminary graphite sheets containing an amorphous carbon body, an amorphous carbon body, and/or an amorphous carbon body. The process may include, for example, raising and maintaining the temperature of the polyimide films at a vacuum or an inert gas atmosphere from room temperature to the highest temperature in the range of 1,000° C. to 1,500° C. for 10 to 30 hours, but is not limited to thereto. Optionally, pressure may be applied to the polyimide films using a hot press during carbonization to achieve high carbon orientation. The pressure at this time may be in a range of, for example, 5 kg/cm² or more, for another example, 15 kg/cm² or more, and for yet another example, 25 kg/cm² or more, but is not limited thereto.

Graphitization is a process of rearranging the carbon of an amorphous carbon body, an amorphous carbon body, and/or an amorphous carbon body to form graphite sheets. For example, the process may include raising and maintaining the temperature of the preliminary graphite sheets, optionally in an inert gas atmosphere, from room temperature to a maximum temperature in the range of 2,500° C. to 3,000° C. for 2 to 30 hours, but is limited thereto. Optionally, pressure may be applied to the graphite sheets using a hot press during graphitization to achieve high carbon orientation. The pressure at this time may be in a range of, for example, 100 kg/cm² or more, for another example, 200 kg/cm² or more, and for yet another example, 300 kg/cm² or more, but is not limited thereto.

### Mode for Disclosure

Hereinafter, the present disclosure will be described in more detail through examples. However, the examples are presented as preferred examples of the present disclosure, and should not be construed as limiting the present disclosure in any way.

### Preparation Example 1 (Preparation of Polyimide Films)

205.0 g of dimethylformamide (DMF) as a solvent was added to the reactor, and the temperature was set to 23° C. Here, 21.5 g of 4,4′-oxydianiline (ODA) was added as a diamine monomer, and then 23.4 g of pyromellitic dianhydride (PMDA) was added as a dianhydride monomer to prepare a polyamic acid solution with a viscosity of 230,000 cP.

Next, 0.12 g of dicalcium phosphate (average particle diameter (D 50): 2.5 μm) as a sublimable inorganic filler, an appropriate amount of acetic anhydride (AA), and an appropriate amount of dimethylformamide were mixed with the prepared polyamic acid solution.

In addition, a polyimide film precursor solution was prepared by adding an appropriate amount of two imidization catalysts (quinoline (QL) and β-picoline (BP)).

The prepared polyimide film precursor solution was cast on a SUS plate (100SA, Sandvik) at a thickness of 500 μm using a doctor blade and dried at a temperature in a range of 100° C. to 200° C. to prepare a self-supporting gel film.

Next, the gel film was peeled from the SUS plate, fixed to a pin frame, and transferred to a high-temperature tenter. The film was heated from 200° C. to 700° C. in the high-temperature tenter, cooled to 25° C., and then separated from the pin frame to obtain a 125 μm thick polyimide film.

### Preparation Example 2 (Preparation of Graphite Sheets)

The polyimide film prepared in Preparation Example 1 was heated to 1,210° C. at a rate of 3.3° C./min under a nitrogen gas atmosphere using an electric furnace capable of inducing carbonization, and the polyimide film remained at 1,210° C. for about 2 hours (carbonization).

Subsequently, a first calcination was performed by raising the temperature from 1,210° C. to 2, 200° C. at a temperature increase rate of 2.5° C./min under an argon gas atmosphere using an electric furnace capable of inducing graphitization.

After the temperature reached 2,200° C., the temperature increase rate was changed to 1.25° C./min and the temperature was continuously raised to 2,500° C. to perform a second calcination.

After the temperature reached 2,500° C., the temperature increase rate was changed to 10° C./min, and a third calcination was performed by continuously raising the temperature to 2, 800° C. After the state remained at a temperature of 2, 800° C. for several minutes, graphitization was completed to produce a graphite sheet.

Finally, the graphite sheet was cooled at a rate of 10° C./min.

### Examples 1 to 8 and Comparative Examples 1 to 3

When preparing the polyimide film according to Preparation Example 1, the respective contents of two imidization catalysts (quinoline (QL) and β-picoline (BP)), acetic anhydride (AA) as a dehydrating agent, and dimethylformamide (DMF) was adjusted based on 1 mol of amic acid group in polyamic acid as shown in Table 1 below and added. Afterward, a graphite sheet was prepared according to Preparation Example 2.

TABLE 1

| | BP | QL | AA | DMF | Tensile | Thickness |
|---|---|---|---|---|---|---|
| Examples | (mol %) | (mol %) | (mol %) | (mol %) | strain (%) | (μm) |
| Example 1 | 0.7 | 0.7 | 3.0 | 1.1 | 117 | 125 |
| Example 2 | 0.7 | 0.7 | 3.0 | 1.5 | 111 | |
| Example 3 | 0.7 | 0.7 | 3.4 | 1.5 | 113 | |
| Example 4 | 0.7 | 0.7 | 2.7 | 2.2 | 107 | |
| Example 5 | 0.5 | 1.1 | 2.5 | 1.7 | 133 | |
| Example 6 | 0.5 | 1.3 | 2.5 | 1.7 | 106 | |
| Example 7 | 0.4 | 0.4 | 2.0 | 2.5 | 166 | |
| Example 8 | 0.3 | 0.3 | 1.7 | 3.0 | 147 | |
| Comparative Example 1 | 0.7 | 0.0 | 2.7 | 2.2 | 31 | |
| Comparative Example 2 | 0.5 | 0.0 | 2.4 | 2.5 | 62 | |
| Comparative Example 3 | 0.5 | 0.0 | 2.4 | 2.5 | 54 | |

### Experiment Example 1

The tensile strain of the polyimide films of Examples 1 to 8 and Comparative Examples 1 to 3 was measured.

The tensile strain in the machine direction (MD) of the polyimide films was measured using INSTRON 5564 EHP 9918 in accordance with ASTM D882.

The tensile strain of the polyimide films of all examples exceeded 100%.

Through comparison of the tensile strain measurement results of the polyimide films of Examples 1 and 2, it was confirmed that the tensile strain decreased as the DMF content increased.

Through comparison of the tensile strain measurement results of the polyimide films of Examples 2 and 3, it was confirmed that the tensile strain increased as the content of acetic anhydride, which was a dehydrating agent, increased.

This change in tensile strain could also be confirmed in Example 4 with the polyimide film having a decreased tensile strain. In Example 4, the content of DMF was increased and the content of acetic anhydride, a dehydrating agent, was reduced compared to Examples 1 to 3.

Through Examples 5 and 6 in which the mols ratio of the two types of imidization catalysts was changed, as the ratio between the mol % of quinoline and the mol % of picoline (mol % of quinoline/mol % of picoline) increases, it was confirmed that the tensile strain of the polyimide films decreased.

Through Examples 7 and 8 in which the content of the two imidization catalysts (quinoline (QL) and β-picoline (BP)) was reduced while maintaining the mole ratio (mol % of quinoline/mol % of picoline) at 1, it was confirmed that a polyimide film with excellent tensile strain properties could be obtained by controlling the appropriate content and content ratio of the imidization catalysts, acetic anhydride, and DMF.

In addition, as a result of analyzing the polyimide films of Examples 1 to 8 using a thermogravimetric analyzer-mass spectrometer (TGA-MS) device, a compound with a molecular weight of 129 g/mol was detected. The detected compound was determined to be quinoline contained in the polyimide films of Examples 1 to 8.

On the other hand, the tensile strain of the polyimide films of Comparative Examples 1 to 3 not containing quinoline was greatly reduced.

For example, in Comparative Example 1 in which the same condition of Example 4 was set except that quinoline was excluded, the tensile strain was greatly reduced.

On the other hand, when β-picolin (BP) was not used out of the two imidization catalysts, gel film formation did not proceed properly, and a polyimide film was not formed.

That is, when the two types of imidization catalysts (quinoline (QL) and β-picoline (BP)) were contained in appropriate amounts as in Examples 1 to 8, and acetic anhydride, which was a dehydrating agent, and DMF were adjusted to appropriate amounts, a polyimide film with excellent tensile strain was able to be obtained.

### Experiment Example 2

The thermal diffusion coefficient and foam thickness of the graphite sheet using the polyimide film of the example prepared according to Example 2 were measured.

The thermal diffusion coefficient in the plane direction was measured by a Laser Flash method using a measuring device (Netsch, LFA 467), and the foam thickness was measured using a Digital Micrometer (Standard-type, Mitutoyo).

Through measurements, it was confirmed that when the polyimide films of Examples were used, graphite sheets with thermal diffusion and foaming properties were prepared.

The examples of the preparation method of the present disclosure are only preferred examples that allow those skilled in the art to easily practice the present disclosure and are not limited to the above-described examples. Thus, the scope of rights of the present disclosure is not limited. Therefore, the true scope of technical protection of the present disclosure should be determined by the technical spirit of the attached patent claims. In addition, it will be clear to those skilled in the art that various substitutions, modifications, and changes can be made without departing from the technical spirit of the present disclosure, and it is obvious that parts that can be easily changed by those skilled in the art are also included in the scope of rights of the present disclosure.

### INDUSTRIAL APPLICABILITY

The present disclosure has the effect of providing high thickness polyimide films securing the uniform properties of the surface and interior by using two types of imidization catalysts together and having excellent tensile strain properties that do not cause fractures during film preparation, a method of preparing graphite sheets with the polyimide films, and the graphite sheets with excellent properties prepared therewith.

1. A polyimide film obtained by imidizing polyamic acid containing acetic anhydride as a dehydrating agent and comprising quinoline and β-picoline as imidization catalysts.

2. The polyimide film of claim 1, wherein the quinoline is contained in an amount in a range of 0.1 mol % or more and 1.5 mol % or less, based on 1 mol of amic acid groups in the polyamic acid, and
the β-picolin is contained in an amount in a range of 0.1 mol % or more and 1 mol % or less, based on 1 mol of amic acid groups in the polyamic acid.

3. The polyimide film of claim 1, wherein the ratio of the mol % of the quinoline and the mol % of the β-picoline (mol % of quinoline/mol % of β-picoline) is in a range of 1 or more and 3 or less.

4. The polyimide film of claim 1, wherein the acetic anhydride is contained in an amount in a range of 1 mol % or more and 4 mol % or less based on 1 mol of amic acid groups in the polyamic acid.

5. The polyimide film of claim 1, wherein the ratio of the mol % of the β-picoline and the mol % of the acetic anhydride (mol % of β-picoline/mol % of acetic anhydride) is in a range of 0.11 or more and 0.50 or less.

6. The polyimide film of claim 1, wherein the polyamic acid comprises dimethylformamide (DMF) in an amount in a range of 1 mol % or more and 3 mol % or less, based on 1 mol of amic acid groups in the polyamic acid.

7. The polyimide film of claim 1, wherein the polyimide film is formed from:
dianhydride a monomer comprising pyromellitic dianhydride, 3,3′,4,4′-biphenyltetracarboxylicacid dianhydride, 2,3,3′,4-biphenyltetracarboxylicacid dianhydride, oxydiphthalic anhydride, bis(3,4-dicarboxyphenyl) sulfone dianhydride, and 3,3′,4,4′-benzophenonetetracarboxylicacid dianhydride, or combinations thereof; and
a diamine monomer comprising 4,4′-oxydianiline, 3,4′-oxydianiline, p-phenylenediamine, m-phenylenediamine, 4,4′-methylenedianiline, and 3,3′-methylenedianiline, or combinations thereof.

8. The polyimide film of claim 1, wherein the polyimide film is one used for preparing a graphite sheet.

9. A method of preparing a graphite sheet, the method comprising carbonizing the polyimide film of claim 1, graphitizing the polyimide film, or carbonizing and graphitizing the polyimide film.
